(19) United States
(12) Patent Application Publication
(10) Pub. No.: US 2026/0147137 A1
(43) Pub. Date: May 28, 2026

(54) SYSTEMS AND METHODS FOR DETERMINING WEATHER CONDITIONS WITHIN AN AIRSPACE

(71) Applicant: THE BOEING COMPANY, Arlington, VA (US)

(72) Inventors: Chaitra Jagadeesh, Bangalore (IN); Ajaya Srikanta Bharadwaja, Bangalore (IN); Selvakumar Santharam, Bangalore (IN)

(73) Assignee: THE BOEING COMPANY, Arlington, VA (US)

(21) Appl. No.: 18/956,580

(22) Filed: Nov. 22, 2024

(51) Int. Cl. G01W 1/08; B64D 45/00

(52) U.S. Cl. CPC G01W 1/08; B64D 45/00; G01W 2203/00

(57) ABSTRACT

A system and a method include a control unit configured to determine a position of an aircraft within an airspace from tracking information received from a tracking sub-system. The control unit is further configured to associate weather conditions with the position within the airspace. The weather conditions are detected by one or more sensors of the aircraft.

### FIELD OF THE DISCLOSURE

Examples of the present disclosure generally relate to systems and methods for determining weather conditions at locations within an airspace in which aircraft are operated.

### BACKGROUND OF THE DISCLOSURE

Aircraft are used to transport passengers and cargo between various locations. Numerous aircraft depart from and arrive at a typical airport every day.

As an aircraft flies from a departure airport to an arrival airport along a flight path, weather conditions can change. Weather conditions are monitored and considered during flight planning. Various weather forecasting services are available which provide wind, temperature, and other weather parameters. However, forecasted weather data from such sources can be relatively old (such as 6 hours), and might not accurately portray the weather conditions for various locations along a flight path. In general, forecasting models typically provide predictions based on existing data, and might not be accurate in relation to dynamically changing weather conditions.

### SUMMARY OF THE DISCLOSURE

A need exists for a system and a method for determining accurate weather conditions at various locations along a flight path of an aircraft. Further, a need exists for a system and a method for providing accurate weather conditions at future locations of an aircraft within a flight path between a departure airport and a destination airport.

With those needs in mind, certain examples of the present disclosure provide a system including a control unit configured to determine a position of an aircraft within an airspace from tracking information received from a tracking sub-system. The control unit is further configured to associate weather conditions with the position within the airspace. The weather conditions are detected by one or more sensors of the aircraft.

In at least one example, the control unit can be further configured to output the weather conditions at the position of the aircraft to other aircraft at other positions within the airspace.

The control unit can be further configured to one or both of show the weather conditions on a display of the other aircraft, or broadcast the weather conditions through a speaker of the other aircraft.

The aircraft can include the control unit. As another example, the control unit is separate and distinct from the aircraft.

In at least one example, the tracking sub-system is an automatic dependent surveillance-broadcast (ADS-B) tracking sub-system.

In at least one example, the position of the aircraft is within a grid of the airspace. As a further example, the grid includes a latitude range and a longitude range for a portion of the airspace. As a further example, the latitude range is between 1-5 degrees latitude, and the longitude range is between 1-5 degrees longitude.

Certain examples of the present disclosure provide a method including determining, by the control unit, the position of the aircraft within the airspace from the tracking information received from the tracking sub-system; and associating, by the control unit, the weather conditions at the position within the airspace, wherein the weather conditions are detected by the one or more sensors of the aircraft. In at least one example, the method also includes outputting, by the control unit, the weather conditions at the position of the aircraft to other aircraft at other positions within the airspace.

### BRIEF DESCRIPTION OF THE DRAWINGS

FIG. 1 illustrates a block diagram of a system, according to an example of the present disclosure.

FIG. 2 illustrates a simplified view of a flight path between a departure airport and an arrival airport, according to an example of the present disclosure.

FIG. 3 illustrates a flow chart of a method, according to an example of the present disclosure.

FIG. 4 illustrates a schematic block diagram of a control unit, according to an example of the present disclosure.

FIG. 5 illustrates a perspective front view of an aircraft, according to an example of the present disclosure.

### DETAILED DESCRIPTION OF THE DISCLOSURE

The foregoing summary, as well as the following detailed description of certain examples will be better understood when read in conjunction with the appended drawings. As used herein, an element or step recited in the singular and preceded by the word “a” or “an” should be understood as not necessarily excluding the plural of the elements or steps. Further, references to “one example” are not intended to be interpreted as excluding the existence of additional examples that also incorporate the recited features. Moreover, unless explicitly stated to the contrary, examples “comprising” or “having” an element or a plurality of elements having a particular condition can include additional elements not having that condition.

Examples of the present disclosure provide systems and methods for providing real time weather information to an aircraft, which can be obtained through Aircraft Communications Addressing and Reporting System (ACARS) messages, from other aircraft currently flying within an airspace, such as along a flight path. ACARS is a digital datalink system which transmits short messages between aircraft and ground stations, such as through radio signals or satellites. The weather information can be provided via an ACARS message, and/or another communication message, and can be provided to a user interface when a request for such information is made. In at least one example, the weather information received from other aircraft within an airspace can be used to replace a master weather grid.

The systems and methods described herein provide accurate weather information to operators or aircraft. The increased accuracy of the weather information reduces pilot workload (such as during flight planning). The accurate weather information allows for increased accuracy of estimated times of arrival, and leads to better on-time performance. The accurate weather information provided from other aircraft within an airspace also ensures that pilots are aware of current wind gusts, which helps the pilots plan a flight profile that increases passenger comfort (for example, by avoiding locations of excessive wind gusts). Further, the accurate weather conditions provided by the systems and methods described herein lead to an improved and predictable aviation ecosystem, which reduces fuel burn resulting in reduced cost of operations and reduced carbon emissions.

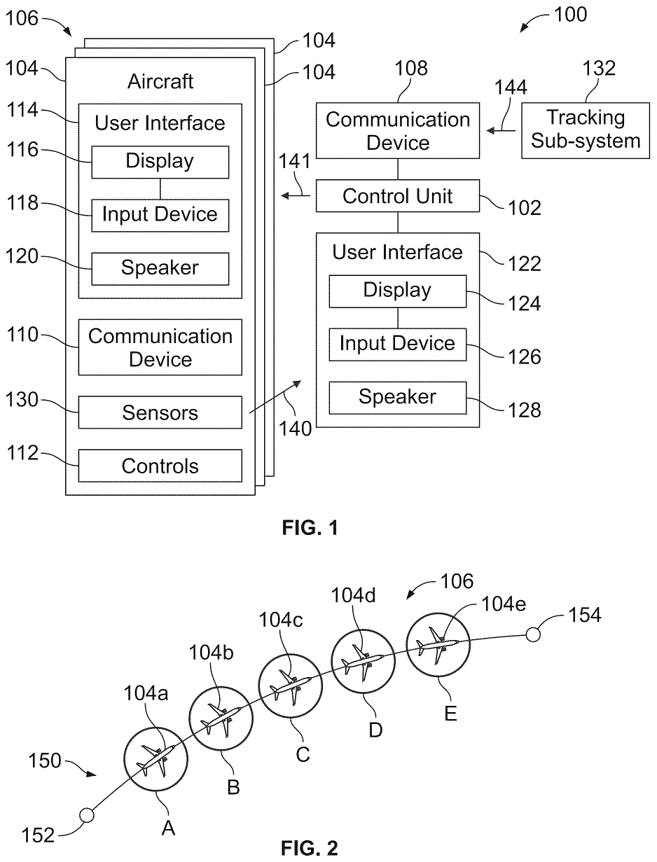

FIG. 1 illustrates a block diagram of a system 100, according to an example of the present disclosure. The system 100 includes a control unit 102 in communication with a plurality of aircraft 104 operating in an airspace 106. For example, the control unit 102 can be coupled to a communication device 108, such as one or more of an antenna, a transceiver, an internet connection, a cloud-based connection, and/or the like. The control unit 102 is in communication with the aircraft 104, such as via communication between the communication device 108 and a communication device 110 of the aircraft 104. For example, the control unit 102 is in communication with all of the aircraft within the airspace 106. The communication device 110 can be an antenna, a transceiver, an internet connection, a cloud-based connection, and/or the like.

In at least one example, the control unit 102 is separate and distinct from the aircraft 104. For example, the control unit 102 can be located at a central monitoring location, which can be remote from the aircraft 104. As another example, the control unit 102 can be onboard one or more of the aircraft 104, such as within a flight deck or cockpit. For example, the control unit 102 can be part of a flight computer of the aircraft 104. In at least one example, each of the aircraft 104 includes a control unit 102.

The aircraft 104 includes controls 112 configured to allow an operator, such as a pilot, to control operation of the aircraft 104. For example, the controls 112 include one or more of a control handle, yoke, joystick, control surface controls, accelerators, decelerators, and/or the like.

The aircraft 104 also includes one or more user interfaces 114. For example, a user interface 114 can be within a flight deck or cockpit of the aircraft 104. As another example, a user interface 114 can be within an internal cabin of the aircraft 104, such as within a galley, or held by a flight attendant. In at least one example, a user interface 114 includes a display 116, an input device 118, and a speaker 120. In at least one example, the display 116 is an electronic device configured to electronically show images, videos, text, and/or the like. For example, the display 116 is configured to electronically show weather information, as described herein. The display 116 can be a monitor, screen, television, touchscreen, and/or the like. The input device 118 can include a keyboard, mouse, stylus, touchscreen interface (that is, the input device 118 can be integral with the display 116), and/or the like. The user interface 114 can be, or part of, a computer workstation. For example, the user interface 114 can be part of the flight computer within the flight deck or cockpit of the aircraft 104. As another example, the user interface 114 can be a handheld device, such as a smart phone, tablet, or the like. The speaker 120 is configured to broadcast audio messages, such as audible messages regarding weather information. Optionally, the user interface 114 may not include the speaker 120.

In at least one example, the control unit 102 can be in communication with a user interface 122 that is not onboard an aircraft 104104, in addition to (or optionally instead of) the user interface 114 onboard one or more aircraft 104104. For example, the user interface 122 can be at a land-based monitoring location, such as with respect to air traffic control, a flight dispatcher, an airline operations center, and/or the like. In at least one example, the control unit 102 is co-located with the user interface 122 at a monitoring location. Like the user interface 114, the user interface 122 can include a display 124, an input device 126, and/or a speaker 128.

The aircraft 104 also includes sensors 130 configured to detect various conditions at locations of the aircraft 104. For example, the sensors 130 are configured to detect weather conditions at a location of the aircraft 104. Examples of the sensors 130 includes a temperature sensor (such as a thermometer) configured to detect an ambient temperature, a barometer configured to detect atmospheric air pressure, a wind sensor (such as a wind vane, wind meter, or the like) configured to detect wind direction and magnitude, and the like. In at least one example, the sensors 130 also include position sensors or components configured to detector and/or output a position (such as a latitude and longitude) of the aircraft 104 within the airspace, an altimeter, and the like.

In at least one example, the control unit 102 is also in communication with a tracking sub-system 132, which is configured to track the various aircraft 104 on the ground and within the airspace 106. In at least one example, the tracking sub-system 132 is configured to track positions of the aircraft 104 in real time. In at least one example, the tracking sub-system 132 is a radar sub-system. As another example, the tracking sub-system 132 is an automatic dependent surveillance-broadcast (ADS-B) tracking sub-system. Real time positions of the aircraft 104 on the ground and within the airspace 106 are detected by the tracking sub-system 132 that receives position signals output by a position sensor of the aircraft 104. For example, the tracking sub-system 132 receives ADS-B signals output by the position sensors of the aircraft 104. As another example, the position sensor of the aircraft 104 can be global positioning system sensors. The position sensor outputs signals indicative of one or more of the position, altitude, heading, acceleration, velocity, and/or the like of the aircraft 104. The signals are received by the tracking sub-system 132. The control unit 102 receives the tracking information of the aircraft 104, such as from the tracking sub-system 132.

FIG. 2 illustrates a simplified view of a flight path 150 between a departure airport 152 and an arrival airport 154, according to an example of the present disclosure. In at least one example, the flight path 150 provides headings, altitudes, waypoints, and the like from the departure airport 152 to the arrival airport 154. In at least one example, the flight path 150 includes numerous grids A, B, C, D, and E between the departure airport 152 and the arrival airport 154. Each grid A-E includes a latitude range and a longitude range for a portion of the airspace 106 between the departure airport 152 and the arrival airport 154. For example, each grid A-E can be a 5 degree latitude×5 degree longitude portion of the airspace 106. Optionally, each grid A-E can be a lesser or greater portion of the airspace 106, such as a 1 degree latitude×1 degree longitude portion of the airspace 106, a 2 degree×2 degree longitude portion of the airspace 106, a 6 degree×6 degree portion of the airspace 106, a 10×10 degree portion of the airspace 106, or the like.

In at least one example, the flight path 150 includes a plurality of connected grids between the departure airport 152 and the arrival airport 154. FIG. 2 shows a simplified representation of the flight path 150 including the grides A-E. It is to be understood that the flight path 150 can include more or fewer grids than shown. Further, the grids can be between other airports. For example, various grids can be shared between different flight paths having different departure airports and different arrival airports.

Referring to FIGS. 1 and 2, in operation, an aircraft 104 can receive weather information from other aircraft within the airspace 106. For example, an aircraft 104 flying within the grid A receives weather information detected by sensors 130 of aircraft 104b within the grid B. In this manner, the aircraft 104a receives real time, accurate weather information from the aircraft 104b within the grid B, which the aircraft 104a is planned to enter at a future time.

The control unit 102 receives the sensed weather information from the aircraft 104 within the airspace 106. For example, the sensors 130 of the aircraft 104 detect various weather conditions, such as air temperature, air pressure, wind speed and direction, and the like, and output a signal 140 regarding weather information including the weather conditions. The control unit 102 outputs a signal 140 including the weather information to other aircraft 104 within the airspace 106. The aircraft 104 receive the signal 141, and the weather information is then shown on the display 116, and/or broadcast through the speaker 120. In this manner, the aircraft 104 within the airspace 106 can receive real time, accurate weather information from other aircraft 104 within the airspace 106, instead of from weather forecasting services.

The tracking sub-system 132 tracks the positions of the aircraft 104 within the airspace 106. The tracking sub-system 132 outputs tracking signals 144 indicative of the tracked positions of the aircraft 104. The control unit 102 receives the tracking signals 144. As such, the control unit 102 determines the positions of the aircraft 104 from the tracking signals 144.

As the control unit 102 detects the positions of the aircraft 104 from the information received from the tracking sub-system 132, the control unit 102 determines the locations of the aircraft 104 within the grids A-E. For example, as the aircraft 104a enters the grid A, the control unit 102 determines the position of the aircraft 104a within the grid A from the tracking information received from the tracking sub-system 132. In response to the aircraft 104a entering the grid A, the control unit 102 receives weather information regarding the weather conditions as detected by the sensors 130 of the aircraft 104a. The control unit 102 then updates the weather conditions within the grid A from the weather information received from the aircraft 104a. In this manner, the control unit 102 determines real time weather conditions within the grid A from the aircraft 104a. The control unit 102 determines: (a) real time weather conditions within grid A from the aircraft 104a, (b) real time weather conditions within grid B from the aircraft 104b, (c) real time weather conditions within grid C from the aircraft 104c, (d) real time weather conditions within grid D from the aircraft 104d, (e) real time weather conditions within grid E from the aircraft 104e, and so on. As such, the control unit 102 provides the real time weather conditions to an aircraft 104 (such as aircraft 104a) at a current position (such as within grid A) from sensed weather conditions provided by other aircraft 104 (such as the aircraft 104b) at future positions (such as within grid B) for the aircraft (such as the aircraft 104a. In this manner, the aircraft 104a is able to receive current, real time weather conditions within future locations within the flight path 150 from other aircraft 104b, 104c, 104d, and 104e at locations ahead of the aircraft 104a within the flight path 150.

The control unit 102 updates the weather conditions within a grid as each aircraft 104 flies into the grid. For example, the control unit 102 determines the weather conditions within grid E, from data received from the sensors 130 of the aircraft 104e. The control unit 102 provides such weather information to other aircraft 104 within the flight path 150. As the aircraft 104d flies into the grid E, the control unit 102 then determines and updates the weather conditions within the grid E based on the data received from the sensors 130 of the aircraft 104d. Thus, the control unit 102 updates the weather conditions within each of the grids A-E in response to the most recent aircraft 104 to enter a grid A-E. In at least one example, when multiple aircraft 104 are within a particular grid, the control unit 102 determines the weather conditions therein from weather information received from the multiple aircraft 104, and can note any differences therebetween.

In at least one example, the control unit 102 automatically provides (without human intervention or prompting) weather information for future locations of the aircraft 104 within the flight path 150. For example, the control unit 102 continuously provides weather information to the aircraft 104a within the grid A for one or more of the grids B-E based on weather conditions as detected by the sensors 130 of the aircraft 104b-e within the grids B-E. In at least one other example, a pilot of the aircraft 104a may output a weather request, via the user interface 114, to the control unit 102 for one or more of the grids. That is, the control unit 102 may output updated, real time weather conditions for future positions of the aircraft 104a within the flight path 150 when a weather request signal is output by the user interface 114 of the aircraft 104a.

As described herein, the system 100 provides a dynamic four dimensional (4D) real-time weather grid computation system. The control unit 102 determines positions of the aircraft 104, such as real-time latitude/longitude and altitude (as detected by one or more sensors 130), and various weather conditions, such as wind magnitude, wind direction, and temperature (as detected from the one or more sensors 130). The control unit 102 determines the real time weather conditions for the detected positions from data received from the aircraft 104 (as opposed to a weather forecasting service). The control unit 102 can then output the weather information for the various positions to the aircraft 104, such as via signals 141, and the weather information can be shown on the display 116 and/or broadcast through the speaker 120 of each of the aircraft 104.

In at least one example, the control unit 102 receives the signal 140 from the aircraft 104. The signal 140 includes one or more of the weather conditions (as detected by the one or more sensors 130) at the current position of the aircraft 104. In at least one example, the signal 140 can be an ACARS message. Optionally, the signal 140 can be ACARS over IP, Internet communications, radio messages, or the like. In at least one example, the control unit 102 receives such information from all of the aircraft 104 within the airspace 106, and creates a master weather grid therefrom. The control unit 102 updates the weather conditions at the various positions in response to subsequent aircraft 104 flying into the positions. When a real-time weather information request is received from an aircraft 104 (such as a pilot inputting a request via the user interface 114), if latest, up-to-date weather data from the other aircraft 104 within the airspace 106 is available, the control unit 102 can output such information to the requesting aircraft 104, which can be shown on the display 116 and/or broadcast through the speaker 120. If, however, latest weather data/information from another aircraft is not available, then the control unit 102 can provide forecasted weather from a weather forecast service (for example, the control unit 102 can also be in communication with a weather forecasting service, such as the National Oceanic and Atmospheric Administration—NOAA), and can indicate that such information is not provided from another aircraft within the airspace 106.

As described herein, the system 100 includes the control unit 102, which is configured to determine a position of an aircraft 104 within an airspace 106 from tracking information received from the tracking sub-system 132, and associate weather conditions with the position within the airspace 106. The weather conditions are detected by one or more sensors 130 of the aircraft 104. In at least one example, the control unit 102 can be further configured to output the weather conditions at the position of the aircraft 104 to other aircraft 104 at other positions within the airspace 106. In at least one example, the control unit 102 can be further configured to one or both of show the weather conditions on a display 116 of the other aircraft 104, or broadcast the weather conditions through a speaker 120 of the other aircraft 104.

The system 100 provides accurate weather information to operators of aircraft 104, which can be used to, for example: (a) improve accuracy of flight plan predictions, (b) increase accuracy of speed adjustments in a flight management system (FMS), thereby saving fuel, (c) reduce pilot workload, (d) increase accuracy of estimated time of arrival, (e) increases passenger comfort (such as allowing pilots to readily re-plan a flight path to avoid areas of inclement weather), (f) reduce carbon emissions, (g) increase precision of vertical required navigation precision (RNP) and dynamic RNP planning, thereby providing a more efficiently used airspace, (h) simulate one or more scenarios, and (i) provide high frequency updates regarding the weather.

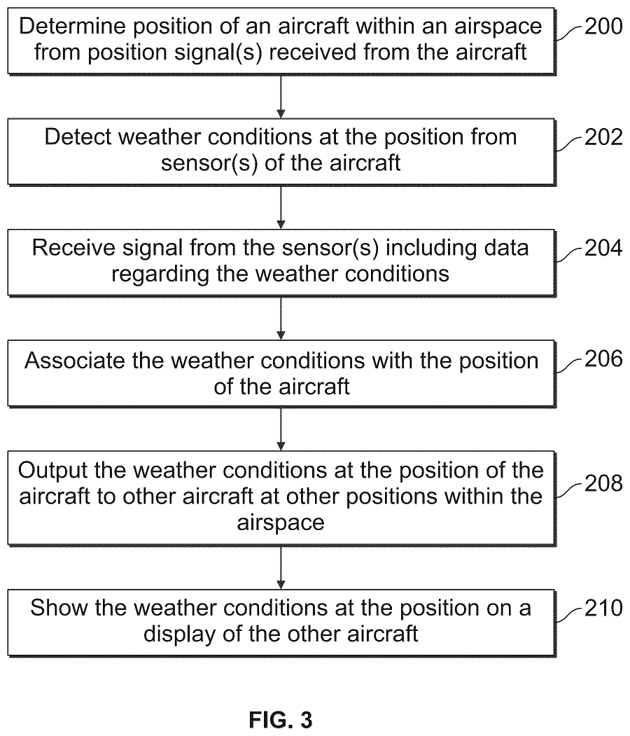

FIG. 3 illustrates a flow chart of a method, according to an example of the present disclosure. Referring to FIGS. 1-3, at 200, the control unit 102 determines a position (for example, a current position) of an aircraft 104 within the airspace 106 from position signals received from the aircraft 104. For example, the tracking sub-system 132 receives the position signals from the aircraft 104, and tracks the position of the aircraft 104. The control unit 102 receives the tracking information from the tracking sub-system 132.

At 202, one or more sensors 130 of the aircraft 104 detect one or more weather conditions (such as wind speed, wind direction, temperature, atmospheric air pressure, and/or the like) at the position of the aircraft 104 (such as within a grid). At 204, the control unit 102 receives one or more signals 140 from the sensor(s) 130. The signals 140 include data regarding the weather conditions, as detected by the sensor(s) 130.

At 206, the control unit 102 then associates the weather conditions, as detected by the sensor(s) 130, with the position of the aircraft 104. At 208, the control unit 102 then outputs the signal(s) 141, which include data regarding the weather conditions at the position of the aircraft 104 to other aircraft 104 at other positions within the airspace 106. At 210, the weather conditions at the position can be shown on a display 116 of the other aircraft 104, and/or broadcast via the speaker 120. In this manner, the control unit 102 can show the weather conditions on the display 116, and/or broadcast the weather conditions via the speaker 120.

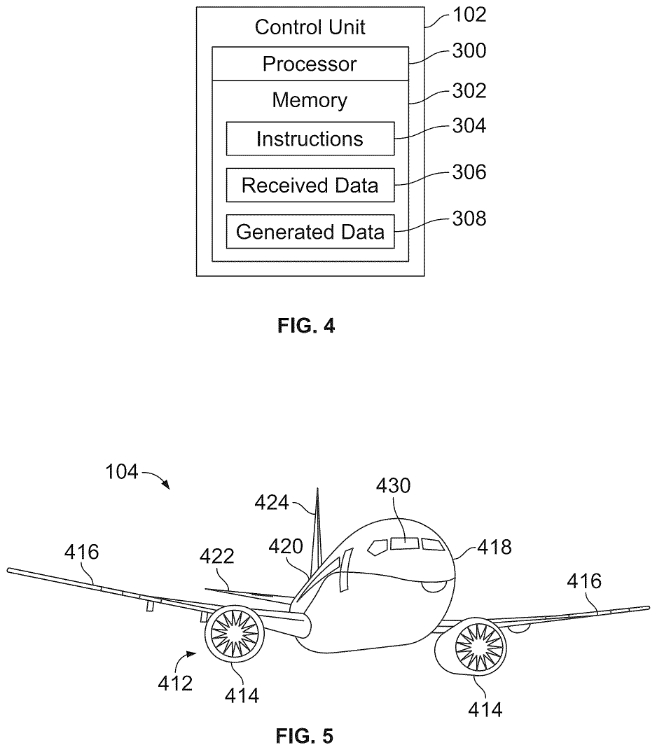

FIG. 4 illustrates a schematic block diagram of the control unit 102, according to an example of the present disclosure. In at least one example, the control unit 102 includes at least one processor 300 in communication with a memory 302. The memory 302 stores instructions 304, received data 306, and generated data 308. The control unit 102 shown in FIG. 4 is merely exemplary, and non-limiting.

As used herein, the term “control unit,” “central processing unit,” “CPU,” “computer,” or the like may include any processor-based or microprocessor-based system including systems using microcontrollers, reduced instruction set computers (RISC), application specific integrated circuits (ASICs), logic circuits, and any other circuit or processor including hardware, software, or a combination thereof capable of executing the functions described herein. Such are exemplary only, and are thus not intended to limit in any way the definition and/or meaning of such terms. For example, the control unit 102 may be or include one or more processors that are configured to control operation, as described herein.

The control unit 102 is configured to execute a set of instructions that are stored in one or more data storage units or elements (such as one or more memories), in order to process data. For example, the control unit 102 may include or be coupled to one or more memories. The data storage units may also store data or other information as desired or needed. The data storage units may be in the form of an information source or a physical memory element within a processing machine.

The set of instructions may include various commands that instruct the control unit 102 as a processing machine to perform specific operations such as the methods and processes of the various examples of the subject matter described herein. The set of instructions may be in the form of a software program. The software may be in various forms such as system software or application software. Further, the software may be in the form of a collection of separate programs, a program subset within a larger program, or a portion of a program. The software may also include modular programming in the form of object-oriented programming. The processing of input data by the processing machine may be in response to user commands, or in response to results of previous processing, or in response to a request made by another processing machine.

The diagrams of examples herein may illustrate one or more control or processing units, such as the control unit 102. It is to be understood that the processing or control units may represent circuits, circuitry, or portions thereof that may be implemented as hardware with associated instructions (e.g., software stored on a tangible and non-transitory computer readable storage medium, such as a computer hard drive, ROM, RAM, or the like) that perform the operations described herein. The hardware may include state machine circuitry hardwired to perform the functions described herein. Optionally, the hardware may include electronic circuits that include and/or are connected to one or more logic-based devices, such as microprocessors, processors, controllers, or the like. Optionally, the control unit 102 may represent processing circuitry such as one or more of a field programmable gate array (FPGA), application specific integrated circuit (ASIC), microprocessor(s), and/or the like. The circuits in various examples may be configured to execute one or more algorithms to perform functions described herein. The one or more algorithms may include aspects of examples disclosed herein, whether or not expressly identified in a flowchart or a method.

As used herein, the terms “software” and “firmware” are interchangeable, and include any computer program stored in a data storage unit (for example, one or more memories) for execution by a computer, including RAM memory, ROM memory, EPROM memory, EEPROM memory, and non-volatile RAM (NVRAM) memory. The above data storage unit types are exemplary only, and are thus not limiting as to the types of memory usable for storage of a computer program.

Referring to FIGS. 1-4, examples of the subject disclosure provide systems and methods that allow large amounts of data to be quickly and efficiently analyzed by a computing device. For example, the control unit 102 can receive and analyze data from dozens, hundreds, thousands, or more aircraft 104 operating within an airspace 106. As such, large amounts of data, which may not be readily discernable by human beings, are being tracked and analyzed. The vast amounts of data are efficiently organized and/or analyzed by the control unit 102, as described herein. The control unit 102 analyzes the data in a relatively short time in order to quickly and efficiently determine current weather conditions at various positions of the airspace 106. As such, examples of the present disclosure provide increased and efficient functionality, and vastly superior performance in relation to a human being reviewing the vast amounts of data.

In at least one example, components of the system 100, such as the control unit 102, provide and/or enable a computer system to operate as a special computer system for determining weather conditions within the airspace. The control unit 102 utilizes information received from the various aircraft 104 to determine the weather conditions within the airspace 106. The control unit 102 improves upon standard computing devices by determining such information and automatically communicating with individuals (such as operators of aircraft, ground support crew, flight attendants, and the like) in an efficient and effective manner.

FIG. 5 illustrates a perspective front view of an aircraft 104, according to an example of the present disclosure. The aircraft 104 includes a propulsion system 412 that includes engines 414, for example. Optionally, the propulsion system 412 may include more engines 414 than shown. The engines 414 are carried by wings 416 of the aircraft 104. In other examples, the engines 414 may be carried by a fuselage 418 and/or an empennage 420. The empennage 420 may also support horizontal stabilizers 422 and a vertical stabilizer 424. The fuselage 418 of the aircraft 104 defines an internal cabin 430, which includes a flight deck or cockpit, one or more work sections (for example, galleys, personnel carry-on baggage areas, and the like), one or more passenger sections (for example, first class, business class, and coach sections), one or more lavatories, and/or the like. FIG. 5 shows an example of an aircraft 104. It is to be understood that the aircraft 104 can be sized, shaped, and configured differently than shown in FIG. 5.

Further, the disclosure comprises examples according to the following clauses:

Clause 1. a system comprising:
a control unit configured to:
   determine a position of an aircraft within an airspace from tracking information received from a tracking sub-system, and
   associate weather conditions with the position within the airspace, wherein the weather conditions are detected by one or more sensors of the aircraft.

Clause 2. The system of Clause 1, wherein the control unit is further configured to output the weather conditions at the position of the aircraft to other aircraft at other positions within the airspace.

Clause 3. The system of Clause 2, wherein the control unit is further configured to one or both of show the weather conditions on a display of the other aircraft, or broadcast the weather conditions through a speaker of the other aircraft.

Clause 4. The system of any of Clauses 1-3, wherein the aircraft comprises the control unit.

Clause 5. The system of any of Clauses 1-3, wherein the control unit is separate and distinct from the aircraft.

Clause 6. The system of any of Clauses 1-5, wherein the tracking sub-system is an automatic dependent surveillance-broadcast (ADS-B) tracking sub-system.

Clause 7. The system of any of Clauses 1-6, wherein the position of the aircraft is within a grid of the airspace.

Clause 8. The system of Clause 7, wherein the grid includes a latitude range and a longitude range for a portion of the airspace.

Clause 9. The system of Clause 8, wherein the latitude range is between 1-5 degrees latitude, and the longitude range is between 1-5 degrees longitude.

Clause 10.A method for a system comprising
a control unit configured to:
   determine a position of an aircraft within an airspace from tracking information received from a tracking sub-system, and
   associate weather conditions with the position within the airspace, wherein the weather conditions are detected by one or more sensors of the aircraft,
the method comprising:
   determining, by the control unit, the position of the aircraft within the airspace from the tracking information received from the tracking sub-system; and
   associating, by the control unit, the weather conditions at the position within the airspace, wherein the weather conditions are detected by the one or more sensors of the aircraft.

Clause 11. The method of Clause 10, further comprising outputting, by the control unit, the weather conditions at the position of the aircraft to other aircraft at other positions within the airspace.

Clause 12. The method of Clause 11, further comprising one or both of showing the weather conditions on a display of the other aircraft, or broadcasting the weather conditions through a speaker of the other aircraft.

Clause 13. The method of any of Clauses 10-12, wherein the tracking sub-system is an automatic dependent surveillance-broadcast (ADS-B) tracking sub-system.

Clause 14. The method of any of Clauses 10-13, wherein the position of the aircraft is within a grid of the airspace.

Clause 15. The method of Clause 14, wherein the grid includes a latitude range and a longitude range for a portion of the airspace.

Clause 16. The method of Clause 15, wherein the latitude range is between 1-5 degrees latitude, and the longitude range is between 1-5 degrees longitude.

Clause 17.A system comprising:
a tracking sub-system configured to track positions of a plurality of aircraft within an airspace;
an aircraft comprising one or more sensors configured to detect weather conditions at a position of the aircraft; and
a control unit configured to:
   determine the position of the aircraft within the airspace from tracking information received from the tracking sub-system,
   associate the weather conditions, as detected by the one or more sensors of the aircraft, with the position within the airspace, and
   output the weather conditions at the position of the aircraft to other aircraft at other positions within the airspace.

Clause 18. The system of Clause 17, wherein the control unit is further configured to one or both of show the weather conditions on a display of the other aircraft, or broadcast the weather conditions through a speaker of the other aircraft.

Clause 19. The system of Clauses 17 or 18, wherein the tracking sub-system is an automatic dependent surveillance-broadcast (ADS-B) tracking sub-system.

Clause 20. The system of any of Clauses 17-19, wherein the position of the aircraft is within a grid of the airspace, wherein the grid includes a latitude range and a longitude range for a portion of the airspace, and wherein the latitude range is between 1-5 degrees latitude, and the longitude range is between 1-5 degrees longitude.

As described herein, examples of the present disclosure provide systems and methods for determining accurate weather conditions at various locations along a flight path of an aircraft. Further, examples of the present disclosure provide systems and methods for providing accurate weather conditions at future locations of an aircraft within a flight path between a departure airport and a destination airport.

While various spatial and directional terms, such as top, bottom, lower, mid, lateral, horizontal, vertical, front and the like can be used to describe examples of the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described examples (and/or aspects thereof) can be used in combination with each other. In addition, many modifications can be made to adapt a particular situation or material to the teachings of the various examples of the disclosure without departing from their scope. While the dimensions and types of materials described herein are intended to define the aspects of the various examples of the disclosure, the examples are by no means limiting and are exemplary examples. Many other examples will be apparent to those of skill in the art upon reviewing the above description. The scope of the various examples of the disclosure should, therefore, be determined with reference to the appended claims, along with the full scope of equivalents to which such claims are entitled. In the appended claims and the detailed description herein, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various examples of the disclosure, including the best mode, and also to enable any person skilled in the art to practice the various examples of the disclosure, including making and using any devices or systems and performing any incorporated methods. The patentable scope of the various examples of the disclosure is defined by the claims, and can include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A system comprising:
a control unit configured to:
determine a position of an aircraft within an airspace from tracking information received from a tracking sub-system, and
associate weather conditions with the position within the airspace, wherein the weather conditions are detected by one or more sensors of the aircraft.

2. The system of claim 1, wherein the control unit is further configured to output the weather conditions at the position of the aircraft to other aircraft at other positions within the airspace.

3. The system of claim 2, wherein the control unit is further configured to one or both of show the weather conditions on a display of the other aircraft, or broadcast the weather conditions through a speaker of the other aircraft.

4. The system of claim 1, wherein the aircraft comprises the control unit.

5. The system of claim 1, wherein the control unit is separate and distinct from the aircraft.

6. The system of claim 1, wherein the tracking sub-system is an automatic dependent surveillance-broadcast (ADS-B) tracking sub-system.

7. The system of claim 1, wherein the position of the aircraft is within a grid of the airspace.

8. The system of claim 7, wherein the grid includes a latitude range and a longitude range for a portion of the airspace.

9. The system of claim 8, wherein the latitude range is between 1-5 degrees latitude, and the longitude range is between 1-5 degrees longitude.

10. A method for a system comprising
a control unit configured to:
determine a position of an aircraft within an airspace from tracking information received from a tracking sub-system, and
associate weather conditions with the position within the airspace, wherein the weather conditions are detected by one or more sensors of the aircraft,
the method comprising:
determining, by the control unit, the position of the aircraft within the airspace from the tracking information received from the tracking sub-system; and
associating, by the control unit, the weather conditions at the position within the airspace, wherein the weather conditions are detected by the one or more sensors of the aircraft.

11. The method of claim 10, further comprising outputting, by the control unit, the weather conditions at the position of the aircraft to other aircraft at other positions within the airspace.

12. The method of claim 11, further comprising one or both of showing the weather conditions on a display of the other aircraft, or broadcasting the weather conditions through a speaker of the other aircraft.

13. The method of claim 10, wherein the tracking sub-system is an automatic dependent surveillance-broadcast (ADS-B) tracking sub-system.

14. The method of claim 10, wherein the position of the aircraft is within a grid of the airspace.

15. The method of claim 14, wherein the grid includes a latitude range and a longitude range for a portion of the airspace.

16. The method of claim 15, wherein the latitude range is between 1-5 degrees latitude, and the longitude range is between 1-5 degrees longitude.

17. A system comprising:
a tracking sub-system configured to track positions of a plurality of aircraft within an airspace;
an aircraft comprising one or more sensors configured to detect weather conditions at a position of the aircraft; and
a control unit configured to:
determine the position of the aircraft within the airspace from tracking information received from the tracking sub-system,
associate the weather conditions, as detected by the one or more sensors of the aircraft, with the position within the airspace, and
output the weather conditions at the position of the aircraft to other aircraft at other positions within the airspace.

18. The system of claim 17, wherein the control unit is further configured to one or both of show the weather conditions on a display of the other aircraft, or broadcast the weather conditions through a speaker of the other aircraft.

19. The system of claim 17, wherein the tracking sub-system is an automatic dependent surveillance-broadcast (ADS-B) tracking sub-system.

20. The system of claim 17, wherein the position of the aircraft is within a grid of the airspace, wherein the grid includes a latitude range and a longitude range for a portion of the airspace, and wherein the latitude range is between 1-5 degrees latitude, and the longitude range is between 1-5 degrees longitude.
